(19) United States
(12) Patent Application Publication
(10) Pub. No.: US 2015/0300582 A1
(43) Pub. Date: Oct. 22, 2015

(54) Decorative translucent panels

(71) Applicant: Richard Bonneville, Longueuil (CA)

(72) Inventor: Richard Bonneville, Longueuil (CA)

(21) Appl. No.: 14/692,051

(22) Filed: Apr. 21, 2015

(30) Foreign Application Priority Data
Apr. 22, 2014 (GB) 1407108.8

(51) Int. Cl. F21S 4/00; E04C 1/42; F16M 13/02; E04C 2/54

(52) U.S. Cl. CPC F21S 4/003; E04C 2/54; E04C 1/42; F16M 13/022

(57) ABSTRACT

A decorative translucent panel comprises a rectangular frame member including a rectangular front portion and a rectangular rear portion, each of the front and rear portions having an L-shaped stub extending along a length of a bottom edge thereof, and a channel extending along a length of a top edge thereof, such that when the front and rear portions are placed together the L-shaped stubs form a T-shaped connecting portion and the channels form a frame channel connecting portion. A translucent panel adapted to be slid through a slit opening formed between the top edges of the front and rear portions and held therebetween; an elongated bottom connecting member including a channel in a top portion thereof having a C-shaped cross section and adapted to frictionally slide over the T-shaped connecting portion and hold the front and rear portions firmly together along their bottom edges, and an elongated top connecting member including an elongated top portion and an elongated lower portion having a T-shaped cross section, such that the top connecting portion is adapted to frictionally slide along the top surface of the front and rear top portions and frictionally slide into the channel connecting portion to thereby hold the front and rear portions firmly together along their top edges, and wherein the top connecting member further includes an attachment portion adapted to releasably connect the decorative panel to a support member and held in place within a structural opening.

This application claims priority based on request GB1407108.8 filed Apr. 22, 2014

### FIELD OF THE INVENTION

The present invention relates generally to decorative elements but more particularly to decorative translucent panels.

### BACKGROUND OF THE INVENTION

Stained glass windows have been used since the middle ages. Today, they are still being made but are quite expensive. Cheaper alternatives have been developed which used special plastics or paints of various fluidity, textures and colors to reproduce the lead lines and colored glass. Still, these methods involve coloring the sheet glass in a window which makes it hard to clean. Moreover, once done, the stained glass is a rather permanent fixture which is hard to undo, should one change his mind about the looks or the size. There has to be a better way to recreate the feel and look of stained glass.

### SUMMARY OF THE INVENTION

In view of the foregoing disadvantages inherent in the known devices now present in the prior art, the present invention, which will be described subsequently in greater detail, is to provide objects and advantages which are:

To provide for a stained glass alternative for creating decorative translucent panels.

In order to do so, the invention comprises a rectangular frame member including a rectangular front portion and a rectangular rear portion, each of the front and rear portions having an L-shaped stub extending along a length of a bottom edge thereof, and a channel extending along a length of a top edge thereof, such that when the front and rear portions are placed together the L-shaped stubs form a T-shaped connecting portion and the channels form a frame channel connecting portion. A translucent panel adapted to be slid through a slit opening formed between the top edges of the front and rear portions and held therebetween; an elongated bottom connecting member including a channel in a top portion thereof having a C-shaped cross section and adapted to frictionally slide over the T-shaped connecting portion and hold the front and rear portions firmly together along their bottom edges, and an elongated top connecting member including an elongated top portion and an elongated lower portion having a T-shaped cross section, such that the top connecting portion is adapted to frictionally slide along the top surface of the front and rear top portions and frictionally slide into the channel connecting portion to thereby hold the front and rear portions firmly together along their top edges, and wherein the top connecting member further includes an attachment portion adapted to releasably connect the decorative panel to a support member and held in place within a structural opening.

The attachment portion is formed as an elongated transverse member and includes at least one mechanical fastener adapted to extend through the transverse member and into the support member of the structural opening.

The attachment portion is formed as a ball joint member positioned at an upper center point of the top connecting member, such that the decorative panel can be held in a balanced and stable manner therefrom, and wherein the decorative panel can be rotated around a vertical axis through the ball joint member, and wherein the decorative panel further includes a hanging bracket adapted to releasably attach the decorative panel to the support member. The hanging bracket comprising a rectangular central panel, an elongated loop portion connected along a top edge of the rectangular panel, and an elongated bottom portion having a T-shaped cross section attached to a lower edge of the rectangular panel; and an elongated intermediate connecting member having a T-shaped channel within an upper half thereof adapted to frictionally receive and hold the T-shaped bottom portion of the hanging bracket therein, and an elongated split tubular channel within a lower half thereof adapted to receive and hold the ball joint member therein and thereby the frame member therefrom, such that the frame member can be hung from the support member and rotated in front of the structural opening.

Both vertical sides of the frame member include a magnetic member adapted to releasably attach to a magnetic member of an additional adjacent frame member.

The elongated bottom connecting member further includes a second channel in a bottom portion thereof having a C-shaped cross section and facing in the opposite direction of the channel in the top portion thereof. A first hanging bracket adapted to releasably attach the decorative panel on a first side to a first vertical support member, the first hanging bracket comprising a rectangular central panel, an elongated loop portion connected along a top edge of the rectangular panel and adapted to be releasably attached to the first vertical support member, and an elongated bottom portion having a T-shaped cross section attached to a lower edge of the rectangular panel, such that the bottom portion is adapted to be frictionally receive and held within the second channel of the bottom portion of the bottom connecting member, and a second hanging bracket adapted to releasably attach to the decorative panel on a second side opposite from the first side and to a second vertical support member, the second hanging bracket comprising a rectangular central panel, an elongated loop portion connected along a top edge of the rectangular panel and adapted to be releasably attached to the second vertical support member, and an elongated bottom portion having a T-shaped cross section attached to a lower edge of the rectangular panel and adapted to be frictionally received and held by the attachment portion of the top connecting member. The attachment portion of the top connecting member is formed having a C-shaped cross section that is adapted to frictionally receive the T-shaped bottom portion of the second hanging bracket, such that the decorative panel can be suspended horizontally from between the first and second vertical support members.

The translucent panel is formed as a double glazed panel having a space between two glass sheet; and further includes a strip of LED lights positioned in between the glass sheets and extending around and adjacent an inner perimeter formed by the frame member, and further includes a power cord extending from the strip of LED lights, through the frame member, and extending outwardly therefrom, such that the strip of LED lights can be used to light up the decorative panel.

The panels can be combined in various ways so as to create a system of panels including displayed in a horizontal fashion from a pair of vertical pole members.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Exploded view of the invention.

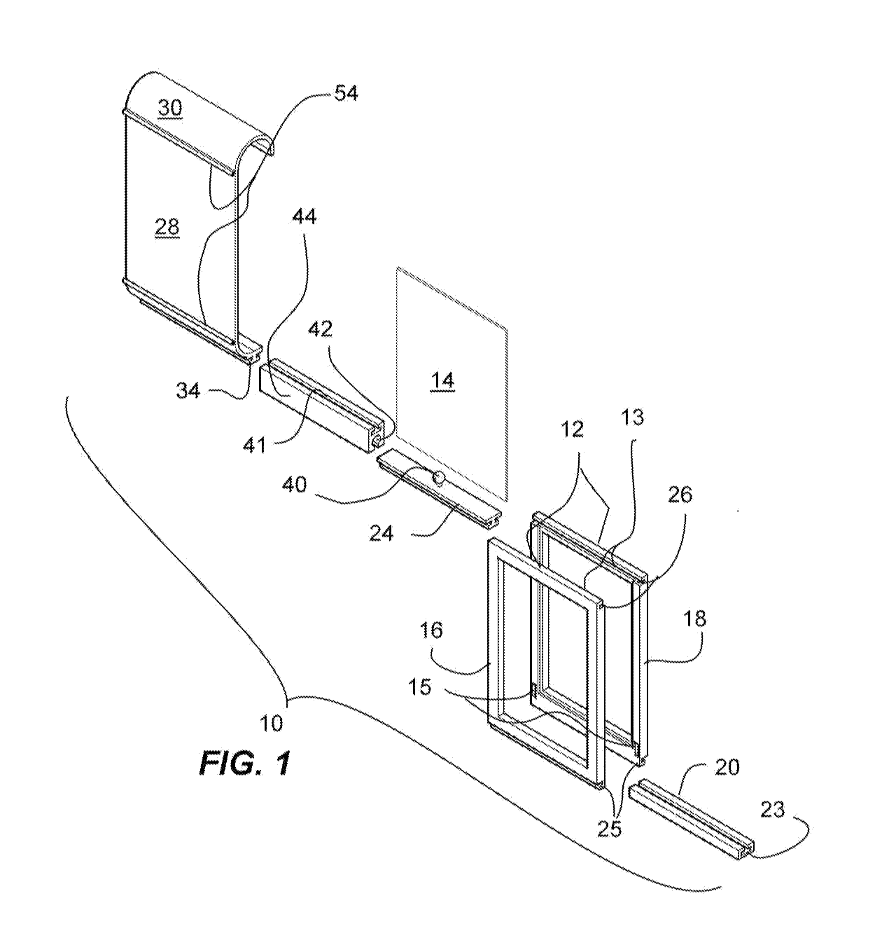

FIG. 2 Isometric view of a swivel frame attached to a long bracket.

FIG. 3 Isometric view as in FIG. 2 but with the frame straight.

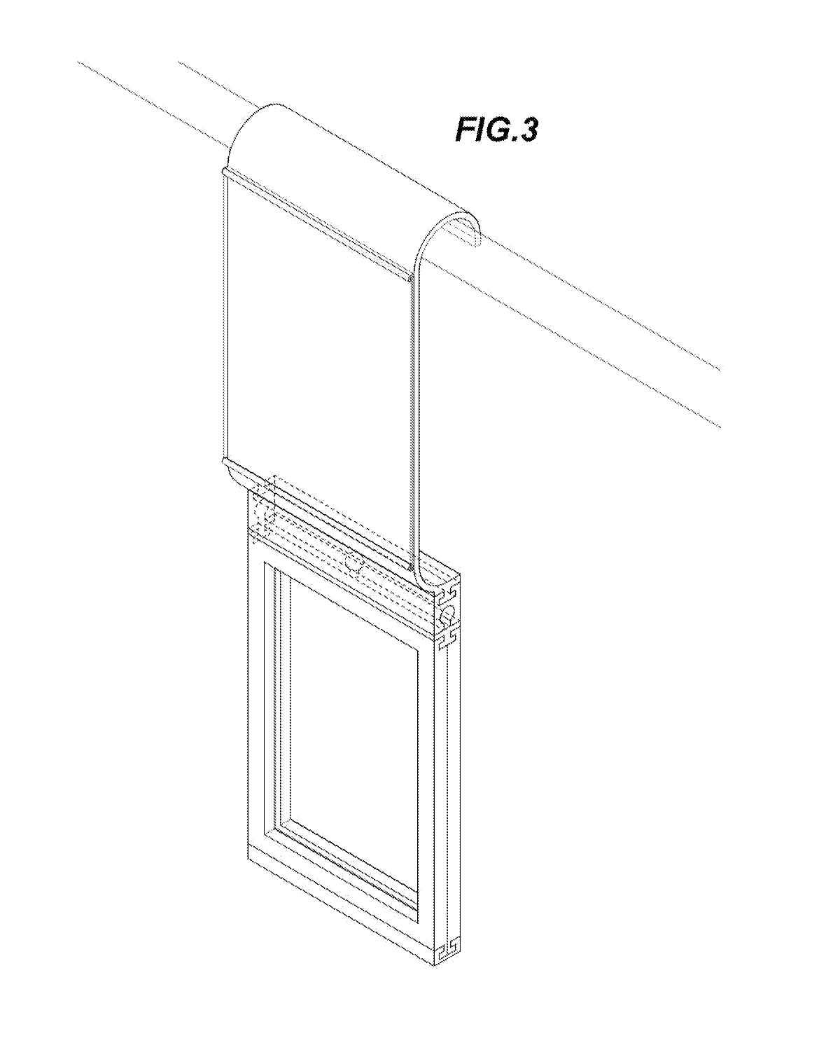

FIG. 4 Isometric view of the frames set horizontally on vertical pole members.

FIG. 5 Front view of multiple rows and columns of frame hung from a single pole member.

FIGS. 6a-b Exploded view and detail of glass holding frame member.

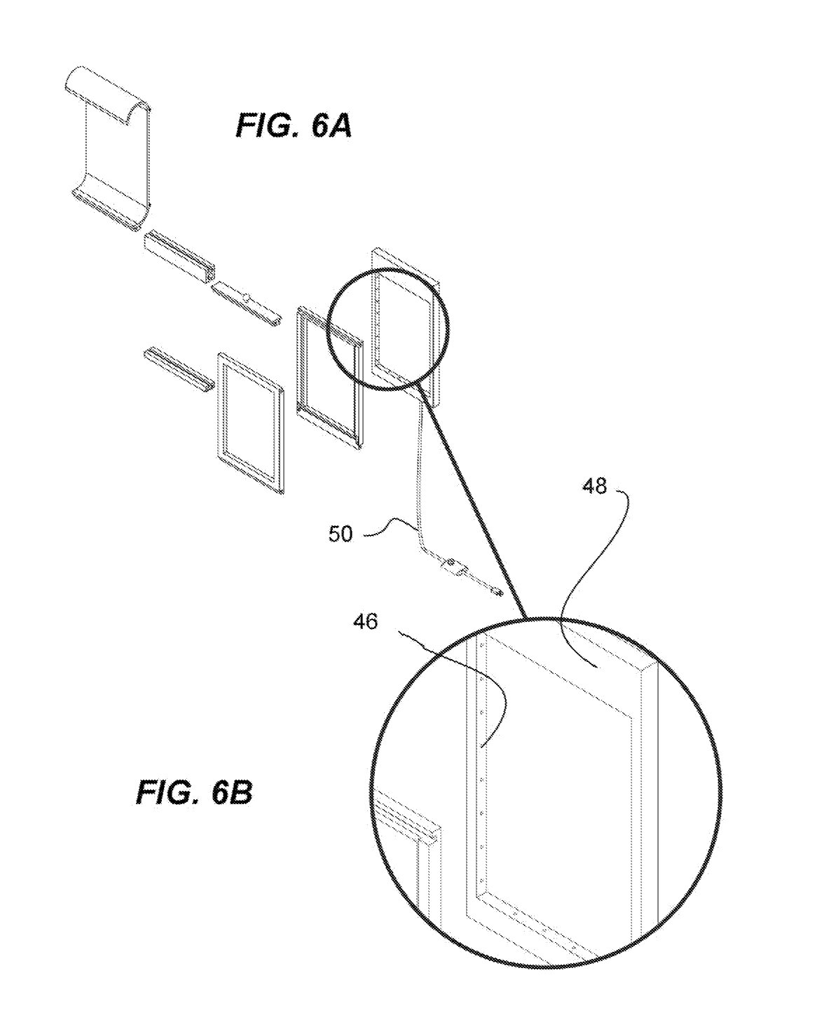

FIG. 7 Isometric view of a frame hung from a transverse member.

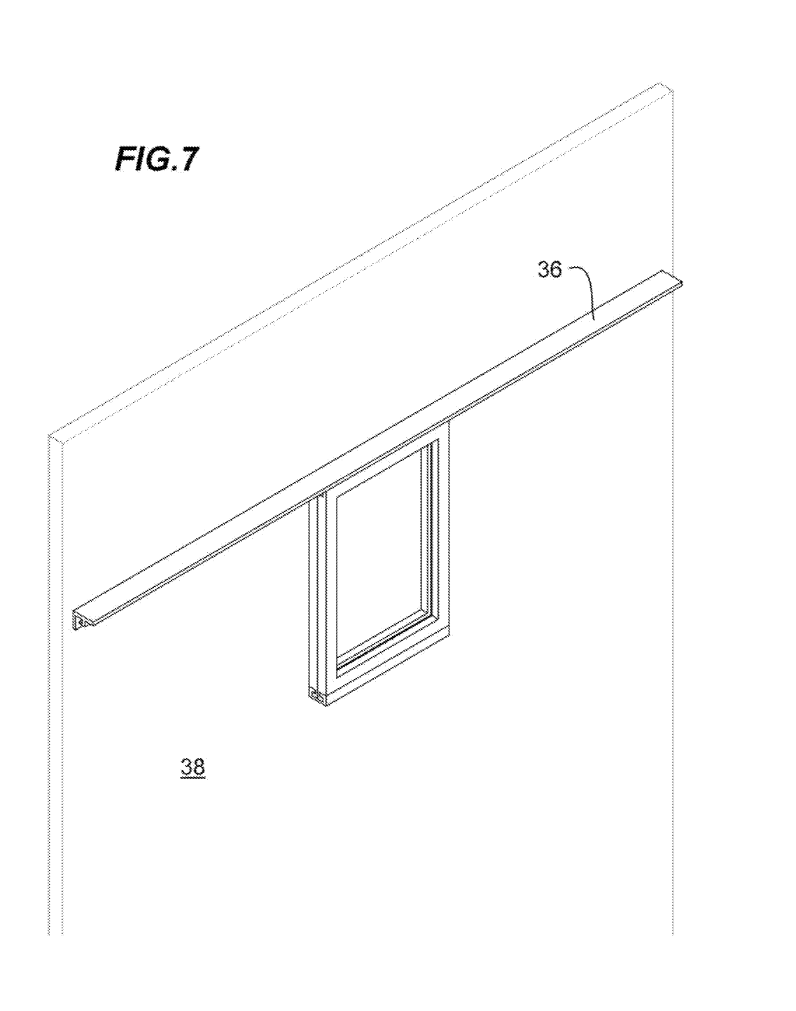

FIG. 8 Side cutaway view of FIG. 7.

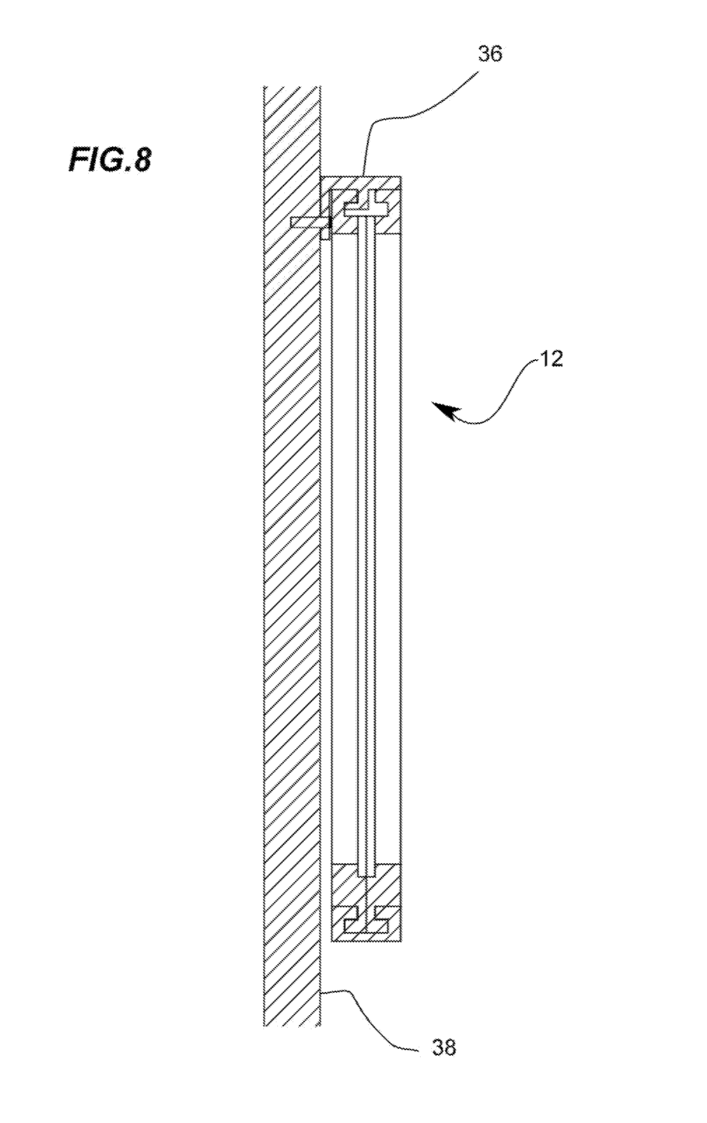

FIG. 9 Isometric view of frame with short bracket.

FIGS. 10a-b Isometric views showing the insertion of a joining panel.

### DETAILED DESCRIPTION

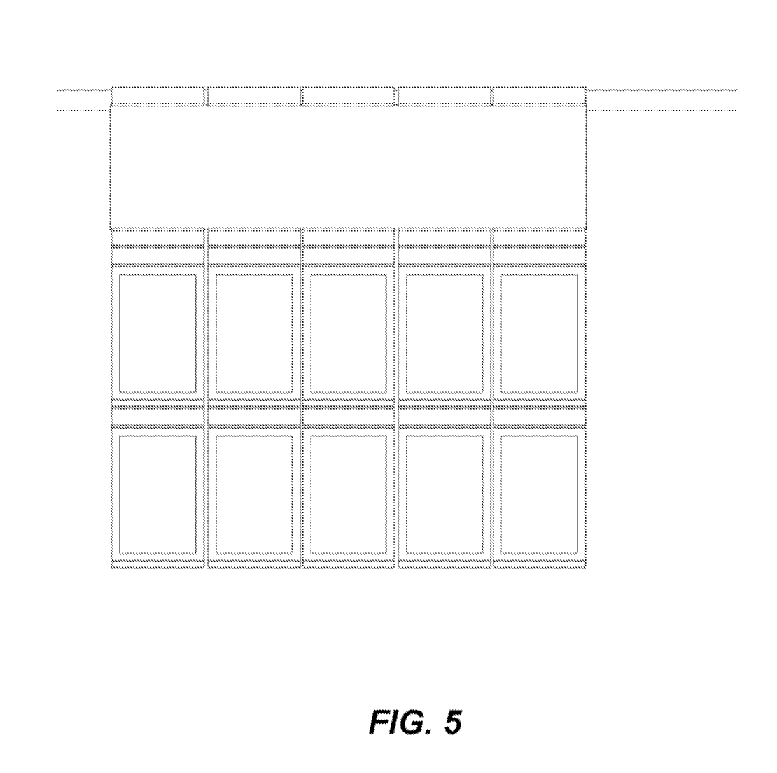

A decorative translucent panel (10) consists in one or more frame members (12), each holding a piece of decorative glass (14). Each frame has a front portion (16), and a rear portion (18). The two portions (16, 18) are connected together by press fit or by an adhesive mean. Moreover, a bottom connecting member (20), and a top connecting member (24) also serve as connector. The glass (14) is slid between the two portions (16, 18)—before inserting a top connecting member (24)—through a slit opening (13) defined by a gap between the top section of the two portions (16, 18). Magnets (15) are used for connecting panels side by side as per FIG. 5 for example.

The bottom connecting member (20) is generally “C” shaped so that a channel (23) is created to receive “L” shaped stubs (25) extending integrally from a bottom section of the front and rear portions (16, 18). Together, the “L” shaped stubs create an inverted “T” which is shaped complementarily from the channel (23). so that a tight fit is created. Similarly, the top connecting member (24) engages the upper part of the frame member (12) with an inverted “T” shape connecting portion which engages a frame channel (26) created when the front and rear portions (16, 18) are joined.

It is important to note that the size and shape of the channels (22, 26) is the same and that both “T” shapes as created by the frame (12) or the top connecting member (20) are also the same shape and size so that there is interchangeability. For example, as seen in FIG. 5, frames (12) can be strung together to form a decorative panel system by having the bottom part of one frame (12) connected to the upper part of the next frame (12).

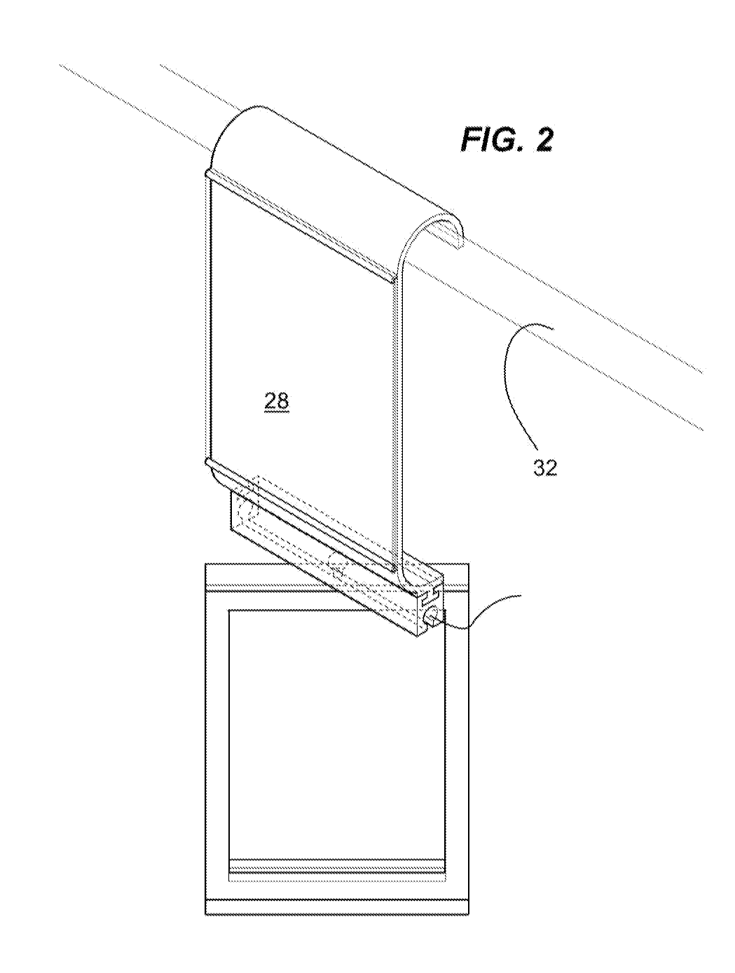

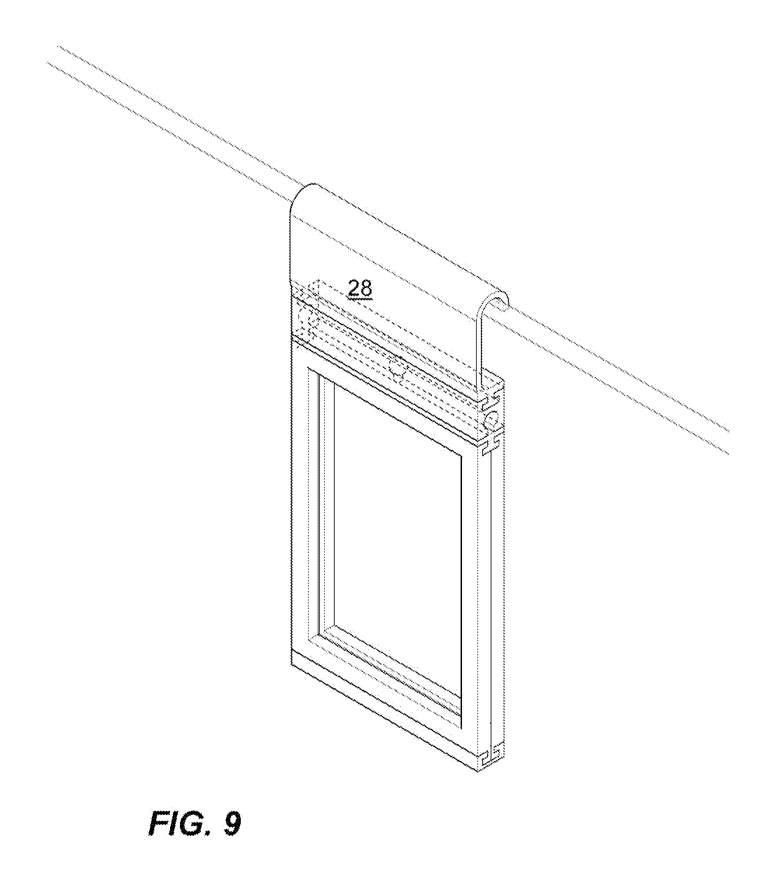

In order to hang a frame (12), at least one of a variety of hardware piece can be used. For example, a hanging bracket (28) (whether long as in FIG. 2 or short as in FIG. 9) has a rectangular central panel and loop portion (30) designed for hooking onto a pole member (32) and a “T” shaped intermediate portion (34) fitting directly into the frame channel member (26).

Another way is by using a transverse member (36) which is mechanically fastened to a vertical surface, such as a wall (38) and having the ubiquitous inverted “T” forming part of its design.

Alternatively, as seen more particularly in FIG. 2 the frames (12) can rotate along a vertical axis by way of a ball joint member (40) extending vertically from the top connecting member (24) which is slidingly inserted into a split tubular channel (42) forming part of an intermediate connecting member (44) which is itself slidingly connected to the “T” shaped bottom portion (34) by way of its “T” shaped channel (41). This is useful when the frames fill an entire window and one still wants to create an opening for wind.

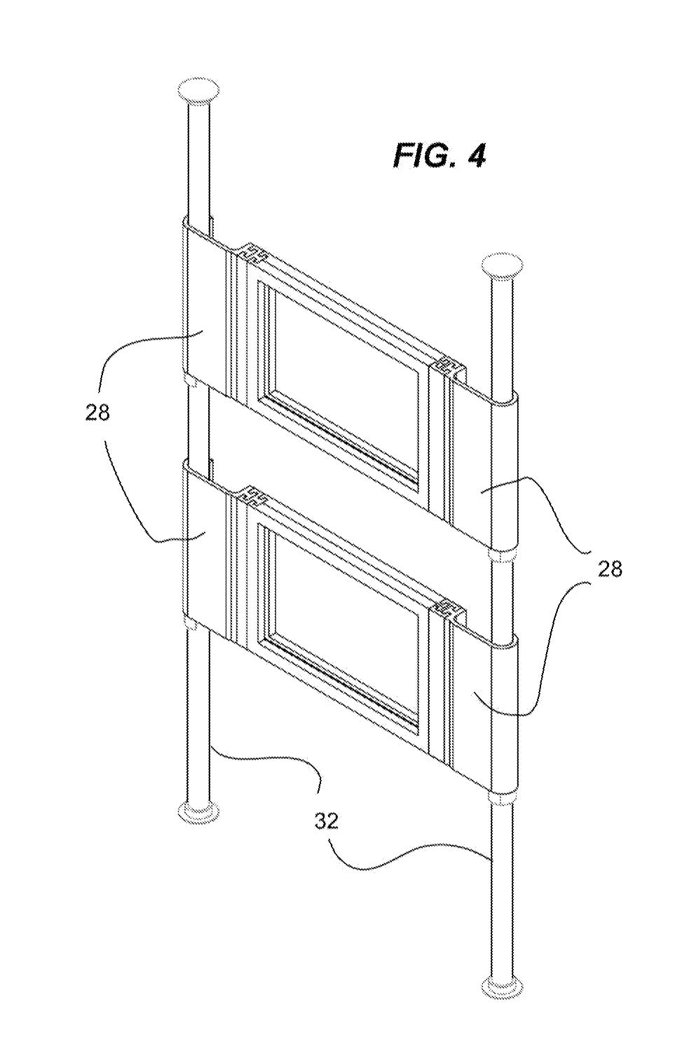

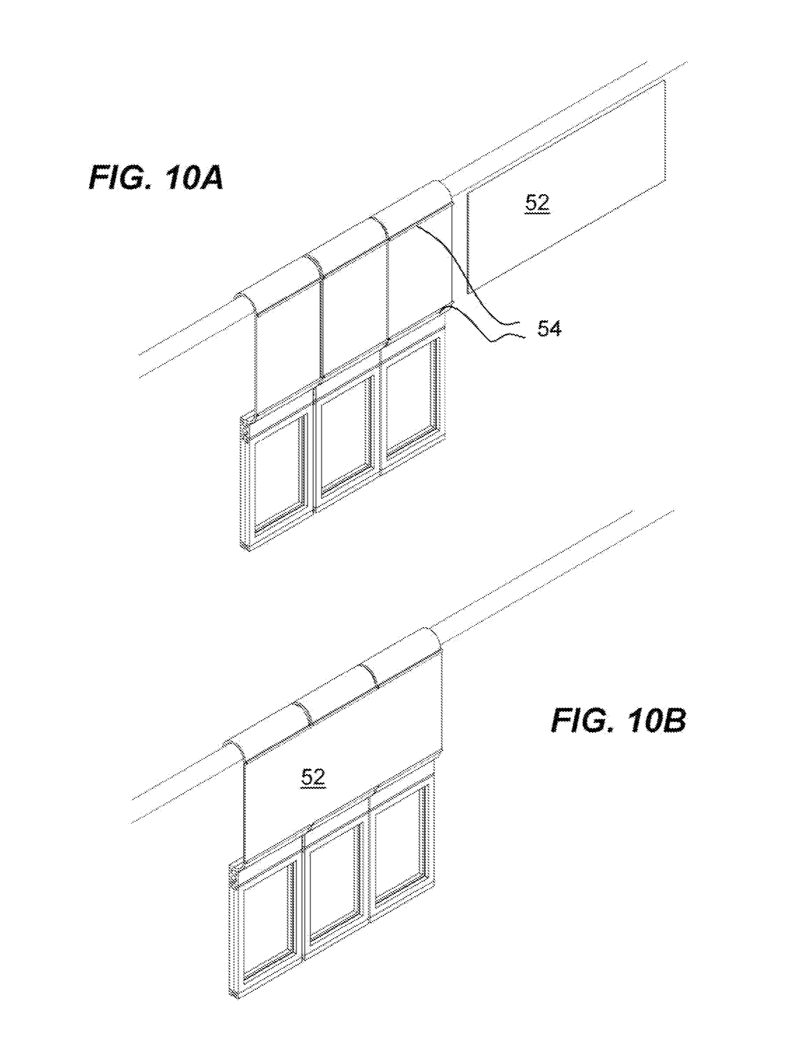

The hanging bracket (28) can also be used in a horizontal fashion as seen in FIG. 4 by way of two spaced apart vertical pole members (32). A row of frames (12) can be further held together by way of a joining panel (52) as seen in FIGS. 10a-b. Wherein the joining panel (52) slides between elongated holding strips (54).

In one variant of the frame (12), one or more strips of LEDs (46) are inserted in a glass holding frame member (48) which substitutes for the decorative glass (14). In this case, double glazing is used, i. e. two sheets of glass (14) are used so that the LED lights (46) are placed thereinbetween so that the frame (12) can glow in the dark. When using two pieces of glass (14) only one need be colored, although both can be. A power cord (50) (or batteries) provides power. LED technology and wiring are known in the art and need not be further discussed.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A decorative panel comprising a rectangular frame member including a rectangular front portion and a rectangular rear portion, each of said front and rear portions having an L-shaped stub extending along a length of a bottom edge thereof, and a channel extending along a length of a top edge thereof, such that when said front and rear portions are placed together said L-shaped stubs form a T-shaped connecting portion and said channels form a frame channel connecting portion; a translucent panel adapted to be slid through a slit opening formed between said top edges of said front and rear portions and held therebetween; an elongated bottom connecting member including a channel in a top portion thereof having a C-shaped cross section and adapted to frictionally slide over said T-shaped connecting portion and hold said front and rear portions firmly together along their bottom edges; and an elongated top connecting member including an elongated top portion and an elongated lower portion having a T-shaped cross section, such that said top connecting portion is adapted to frictionally slide along the top surface of said front and rear top portions and frictionally slide into said channel connecting portion to thereby hold said front and rear portions firmly together along their top edges; and wherein said top connecting member further includes an attachment portion adapted to releasably connect said decorative panel to a support member and held in place within a structural opening.

2. The decorative panel of claim 1, wherein said attachment portion is formed as an elongated transverse member and includes at least one mechanical fastener adapted to extend through said transverse member and into said support member of said structural opening.

3. The decorative panel of claim 1, wherein said attachment portion is formed as a ball joint member positioned at an upper center point of said top connecting member, such that said decorative panel can be held in a balanced and stable manner therefrom, and wherein said decorative panel can be rotated around a vertical axis through said ball joint member; and wherein said decorative panel further includes a hanging bracket adapted to releasably attach said decorative panel to said support member, said hanging bracket comprising a rectangular central panel, an elongated loop portion connected along a top edge of said rectangular panel, and an elongated bottom portion having a T-shaped cross section attached to a lower edge of said rectangular panel; and an elongated intermediate connecting member having a T-shaped channel within an upper half thereof adapted to frictionally receive and hold said T-shaped bottom portion of said hanging bracket therein, and an elongated split tubular channel within a lower half thereof adapted to receive and hold said ball joint member therein and thereby said frame member therefrom, such that said frame member can be hung from said support member and rotated in front of said structural opening.

4. The decorative panel of claim 1, wherein both vertical sides of said frame member include a magnetic member adapted to releasably attach to a magnetic member of an additional adjacent frame member.

5. The decorative panel of claim 1, wherein said elongated bottom connecting member further includes a second channel in a bottom portion thereof having a C-shaped cross section and facing in the opposite direction of said channel in said top portion thereof; a first hanging bracket adapted to releasably attach said decorative panel on a first side to a first vertical support member, said first hanging bracket comprising a rectangular central panel, an elongated loop portion connected along a top edge of said rectangular panel and adapted to be releasably attached to said first vertical support member, and an elongated bottom portion having a T-shaped cross section attached to a lower edge of said rectangular panel, such that said bottom portion is adapted to be frictionally receive and held within said second channel of said bottom portion of said bottom connecting member; and a second hanging bracket adapted to releasably attach to said decorative panel on a second side opposite from said first side and to a second vertical support member, said second hanging bracket comprising a rectangular central panel, an elongated loop portion connected along a top edge of said rectangular panel and adapted to be releasably attached to said second vertical support member, and an elongated bottom portion having a T-shaped cross section attached to a lower edge of said rectangular panel and adapted to be frictionally received and held by said attachment portion of said top connecting member; and wherein said attachment portion of said top connecting member is formed having a C-shaped cross section that is adapted to frictionally receive said T-shaped bottom portion of said second hanging bracket, such that said decorative panel can be suspended horizontally from between said first and second vertical support members.

6. The decorative panel of claim 1, wherein said translucent panel is formed as a double glazed panel having a space between two glass sheet; and further includes a strip of LED lights positioned in between said glass sheets and extending around and adjacent an inner perimeter formed by said frame member; and further includes a power cord extending from said strip of LED lights, through said frame member, and extending outwardly therefrom, such that said strip of LED lights can be used to light up said decorative panel.

7. A decorative panel system comprising at least one pole member adapted to be suspended between support surfaces; and a plurality of decorative panels being hung from said at least one pole member in a side-by-side fashion to thereby form said decorative panel system; wherein each panel comprises a rectangular frame member including a rectangular front portion and a rectangular rear portion, each of said front and rear portions having an L-shaped stub extending along a length of a bottom edge thereof, and a channel extending along a length of a top edge thereof, such that when said front and rear portions are placed together said L-shaped stubs form a T-shaped connecting portion and said channels form a frame channel connecting portion; a translucent panel adapted to be slid through a slit opening formed between said top edges of said front and rear portions and held therebetween; an elongated bottom connecting member including a channel in a top portion thereof having a C-shaped cross section and adapted to frictionally slide over said T-shaped connecting portion and hold said front and rear portions firmly together along their bottom edges; and an elongated top connecting member including an elongated top portion and an elongated lower portion having a T-shaped cross section, such that said top connecting portion is adapted to frictionally slide along the top surface of said front and rear top portions and frictionally slide into said channel connecting portion to thereby hold said front and rear portions firmly together along their top edges; and wherein said top connecting member further includes an attachment portion adapted to releasably connect said decorative panel to a support member and held in place within a structural opening, wherein said attachment portion is formed as a ball joint member positioned at an upper center point of said top connecting member, such that said decorative panel can be held in a balanced and stable manner therefrom, and wherein said decorative panel can be rotated around a vertical axis through said ball joint member; and wherein said decorative panel further includes a hanging bracket adapted to releasably attach said decorative panel to said support member, said hanging bracket comprising a rectangular central panel, an elongated loop portion connected along a top edge of said rectangular panel, and an elongated bottom portion having a T-shaped cross section attached to a lower edge of said rectangular panel; and an elongated intermediate connecting member having a T-shaped channel within an upper half thereof adapted to frictionally receive and hold said T-shaped bottom portion of said hanging bracket therein, and an elongated split tubular channel within a lower half thereof adapted to receive and hold said ball joint member therein and thereby said frame member therefrom, such that said frame member can be hung from said support member and rotated in front of said structural opening.

8. The decorative panel system of claim 7, wherein both vertical sides of each said frame member of each said panel includes a magnetic member adapted to releasably attach to magnetic members of adjacent frame members of adjacent panels.

9. The decorative panel system of claim 7, wherein each said hanging bracket has an elongated holding strip adjacent said top edge of said rectangular panel, and an elongated holding strip adjacent said lower edge of said rectangular panel; and wherein said decorative panel system further comprises a joining panel sized to connect a chosen number of adjacent decorative panels, wherein said joining panel had a length equivalent to the total width of the number of decorative panels to be joined, and a width equal to the distance between said holding strips of said rectangular central panel of each said hanging bracket, and wherein said joining panel is slid between each said holding strips of each said decorative panel, thereby securely holding said decorative panels in a side-by-side fashion.

10. The decorative panel system of claim 7, wherein said bottom connecting member of a plurality of adjacent said decorative panels further includes a second channel having an elongated split tubular channel in a lower portion thereof, such that another said decorative panel frame member having an attachment portion formed as a ball joint member can be connected thereto; and further comprising plurality of additional decorative panel frame members having an attachment portion formed as a ball joint member connected to respective bottom connecting members, to thereby form a larger decorative panel systems adapted to fit within larger structural openings.

11. The decorative panel system of claim 10, wherein both vertical sides of each said plurality of additional decorative panel frame members includes a magnetic member adapted to releasably attach to magnetic members of adjacent frame members of adjacent panels.

12. A decorative panel system comprising two spaced vertical pole members; and a plurality of decorative panels being suspended between said pole members in an side-by-side fashion; wherein each panel comprises a rectangular frame member including a rectangular front portion and a rectangular rear portion, each of said front and rear portions having an L-shaped stub extending along a length of a bottom edge thereof, and a channel extending along a length of a top edge thereof, such that when said front and rear portions are placed together said L-shaped stubs form a T-shaped connecting portion and said channels form a frame channel connecting portion; a translucent panel adapted to be slid through a slit opening formed between said top edges of said front and rear portions and held therebetween; an elongated bottom connecting member including a channel in a top portion thereof having a C-shaped cross section and adapted to frictionally slide over said T-shaped connecting portion and hold said front and rear portions firmly together along their bottom edges; and an elongated top connecting member including an elongated top portion and an elongated lower portion having a T-shaped cross section, such that said top connecting portion is adapted to frictionally slide along the top surface of said front and rear top portions and frictionally slide into said channel connecting portion to thereby hold said front and rear portions firmly together along their top edges; and wherein said top connecting member further includes an attachment portion adapted to releasably connect said decorative panel to a support member and held in place within a structural opening; and wherein said elongated bottom connecting member further includes a second channel in a bottom portion thereof having a C-shaped cross section and facing in the opposite direction of said channel in said top portion thereof; a first hanging bracket adapted to releasably attach said decorative panel on a first side to a first vertical support member, said first hanging bracket comprising a rectangular central panel, an elongated loop portion connected along a top edge of said rectangular panel and adapted to be releasably attached to said first vertical support member, and an elongated bottom portion having a T-shaped cross section attached to a lower edge of said rectangular panel, such that said bottom portion is adapted to be frictionally receive and held within said second channel of said bottom portion of said bottom connecting member; and a second hanging bracket adapted to releasably attach to said decorative panel on a second side opposite from said first side and to a second vertical support member, said second hanging bracket comprising a rectangular central panel, an elongated loop portion connected along a top edge of said rectangular panel and adapted to be releasably attached to said second vertical support member, and an elongated bottom portion having a T-shaped cross section attached to a lower edge of said rectangular panel and adapted to be frictionally received and held by said attachment portion of said top connecting member; and wherein said attachment portion of said top connecting member is formed having a C-shaped cross section that is adapted to frictionally receive said T-shaped bottom portion of said second hanging bracket, such that said decorative panel can be suspended horizontally from between said first and second vertical support members.
